(19) United States
(12) Patent Application Publication
(10) Pub. No.: US 2025/0298215 A1
(43) Pub. Date: Sep. 25, 2025

(54) LENS MODULE AND CAMERA MODULE INCLUDING SAME

(71) Applicant: SAMSUNG ELECTRO-MECHANICS CO., LTD., Suwon-si (KR)

(72) Inventor: Sung Yeon KIM, Suwon-si (KR)

(73) Assignee: SAMSUNG ELECTRO-MECHANICS CO., LTD., Suwon-si (KR)

(21) Appl. No.: 19/023,742

(22) Filed: Jan. 16, 2025

(30) Foreign Application Priority Data
Mar. 21, 2024 (KR) 10-2024-0039343

(51) Int. Cl. G02B 7/02

(52) U.S. Cl. CPC G02B 7/026; G02B 7/025

(57) ABSTRACT

A lens module includes a lens holder having a hollow region; and a lens barrel disposed in the hollow region. A protrusion is disposed on an outer surface of the lens barrel. An injection groove, configured to accommodate adhesive, is disposed on the lens holder. A seating portion, connected to the injection groove, is disposed on an inside surface of the lens holder. The protrusion is disposed on the seating portion.

### CROSS-REFERENCE TO RELATED APPLICATIONS

This application claims the benefit under 35 USC 119(a) of Korean Patent Application No. 10-2024-0039343 filed on Mar. 21, 2024, in the Korean Intellectual Property Office, the entire disclosure of which is incorporated herein by reference for all purposes.

### BACKGROUND

### 1. Field

The present disclosure relates to a lens module and a camera module including the same.

### 2. Description of the Background

Camera modules are not only used in mobile electronic devices such as smartphones, tablet PCs, and notebook computers, but also used in vehicles. A camera module includes a lens module for capturing images.

The lens module includes a lens barrel and a lens holder. A plurality of lenses are disposed in the lens barrel, and the lens barrel is combined with the lens holder. The lens holder combined with the lens barrel is combined with other components of the camera module.

The lens barrel usually has the form of a hollow tube. Therefore, the thickness of a side surface portion is formed thinly, and accordingly, rigidity may also be reduced, where even a small amount of force may cause a slight deformation in the shape of the lens barrel.

Adhesive may be used to bond the lens holder and the lens barrel together. The adhesive may be a liquid adhesive, and the liquid adhesive may harden after being applied. During the process of hardening the liquid adhesive applied between the lens holder and the lens barrel, heat may be generated, and the volume or shape of the adhesive may change.

Therefore, a problem may arise when the lens barrel becomes deformed due to the curing of adhesive if the liquid adhesive flows out of the adhesive application region into another region during the adhesive application process.

The above information is presented as background information only to assist with an understanding of the present disclosure. No determination has been made, and no assertion is made, as to whether any of the above might be applicable as prior art with regard to the disclosure.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a lens module includes a lens holder having a hollow region; and a lens barrel disposed in the hollow region. A protrusion is disposed on an outer surface of the lens barrel. An injection groove, configured to an accommodate adhesive, is disposed on the lens holder. A seating portion, connected to the injection groove, is disposed on an inside surface of the lens holder. The protrusion is disposed on the seating portion.

The seating portion may include a step portion forming a bottom surface of the seating portion, and the step portion may be spaced apart from the injection groove in an optical axis direction.

The step portion may be disposed closer to an image side than the bottom surface of the injection groove.

The step portion may be an inclined surface extending from a surface of the lens holder.

The step portion may form an acute angle with a side surface of the seating portion.

The step portion may be ring-shaped when viewed from an object side.

The protrusion may be ring-shaped and may correspond to the step portion.

The protrusion may include a first surface, a second surface spaced apart from the first surface in the optical axis direction, and a third surface connecting the first surface and the second surface. The second surface may face the bottom surface of the seating portion.

The third surface may face a side surface of the seating portion.

The first surface may be disposed closer to an object side than the second surface.

The injection groove may be trapezoidal shaped with a curved bottom when viewed from an object side.

The injection groove may be disposed in plurality. Each injection groove of the plurality may be disposed spaced apart from another along an inner surface of the lens holder.

The injection groove may become wider when viewed from an image side to an object side.

The adhesive may be injected into the injection groove.

In another general aspect, a camera module includes a housing; a lens module, disposed within the housing, comprising a lens holder having a hollow region, and a lens barrel disposed in the hollow region; and a cover accommodating the housing. The lens holder has a first inner surface, a second inner surface having a smaller inner diameter than the first inner surface, and an injection groove configured to accommodate adhesive. The injection groove is spaced apart from the second inner surface of the lens holder in a direction perpendicular to an optical axis.

A step portion may be disposed between the first inner surface and the second inner surface of the lens holder.

The step portion may be spaced apart from a bottom surface of the injection groove in a direction parallel to the optical axis.

Other features and aspects will be apparent from the following detailed description, the drawings, and the claims.

### BRIEF DESCRIPTION OF DRAWINGS

FIG. 1 is an exploded perspective view of a camera module to which a lens module according to an embodiment of the present disclosure is applied.

FIG. 2 is a perspective view of a lens module according to an embodiment of the present disclosure.

FIG. 3 is an exploded perspective view of a lens module according to an embodiment of the present disclosure.

FIG. 4 is a drawing of a lens module as viewed from an object side.

FIG. 5 is a drawing of a lens barrel as viewed from an object side.

FIG. 6 is a plan view of a lens holder as viewed from an object side.

FIG. 7 is an enlarged drawing of an injection groove of a lens holder.

FIG. 8 is a cross-sectional view, I-I′ in FIG. 4.

FIG. 9A is an enlarged view of a part of FIG. 8, and FIG. 9B is a view illustrating an adhesive together in FIG. 9A.

Throughout the drawings and the detailed description, unless otherwise described, the same reference numerals refer to the same elements. The drawings may not be to scale, and the relative size, proportions, and depiction of elements in the drawings may be exaggerated for clarity, illustration, and convenience.

### DETAILED DESCRIPTION

Hereinafter, while examples of the present disclosure will be described in detail with reference to the accompanying drawings, it is noted that examples are not limited to the same.

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of this disclosure. For example, the sequences of operations described herein are merely examples, and are not limited to those set forth herein, but may be changed as will be apparent after an understanding of this disclosure, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of this disclosure.

Throughout the specification, when an element, such as a layer, region, or substrate is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween.

As used herein, the term “and/or” includes any one and any combination of any two or more of the associated listed items; likewise, “at least one of” includes any one and any combination of any two or more of the associated listed items.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

Spatially relative terms, such as “above,” “upper,” “below,” “lower,” and the like, may be used herein for ease of description to describe one element's relationship to another element as shown in the figures. Such spatially relative terms are intended to encompass different orientations of the device in use or operation in addition to the orientation depicted in the figures. For example, if the device in the figures is turned over, an element described as being “above,” or “upper” relative to another element would then be “below,” or “lower” relative to the other element. Thus, the term “above” encompasses both the above and below orientations depending on the spatial orientation of the device. The device may also be oriented in other ways (rotated 90 degrees or at other orientations), and the spatially relative terms used herein are to be interpreted accordingly.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

Due to manufacturing techniques and/or tolerances, variations of the shapes shown in the drawings may occur. Thus, the examples described herein are not limited to the specific shapes shown in the drawings, but include changes in shape that occur during manufacturing.

Herein, it is noted that use of the term “may” with respect to an example, for example, as to what an example may include or implement, means that at least one example exists in which such a feature is included or implemented while all examples are not limited thereto.

The features of the examples described herein may be combined in various ways as will be apparent after an understanding of this disclosure. Further, although the examples described herein have a variety of configurations, other configurations are possible as will be apparent after an understanding of this disclosure.

The lens module according to embodiments of the present disclosure may be applied to a camera module mounted on a vehicle as well as a portable electronic device. The portable electronic device may be a portable electronic device such as a mobile communication terminal, a smartphone, or a tablet PC.

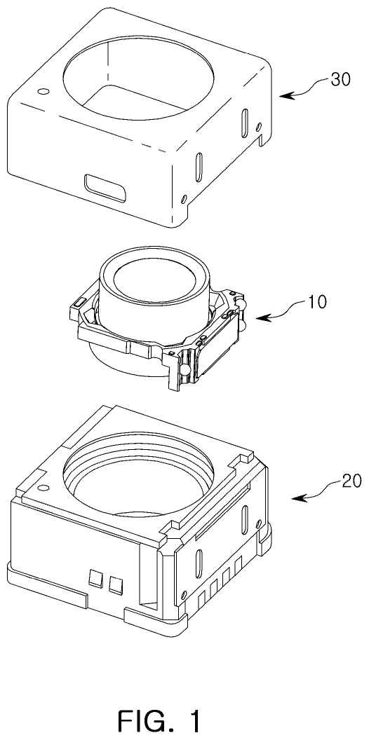

FIG. 1 is an exploded perspective view of a camera module to which a lens module 10 according to an embodiment of the present disclosure is applied.

The lens module 10 according to the present disclosure may be disposed in a camera module. The camera module may include a housing 20, a cover 30, and a lens module 10.

The housing 20 may include a hollow region, and a lens module 10 may be disposed in the hollow region of the housing 20. An actuator not illustrated may be disposed inside the housing 20. The actuator may be configured to move the lens module 10 or the image sensor not illustrated. The actuator may be an actuator for performing an AF Auto Focus or Optical Image Stabilization OIS function.

An image sensor may be disposed inside the housing 20. The image sensor may be disposed at the rear of the lens module 10.

The cover 30 may form an exterior of the camera module. The cover 30 may be a structure surrounding the housing 20. The cover 30 may include a hollow region, and a front of the lens module 10 may be externally exposed through the hollow region of the cover 30. That is, an observer may observe the front of the lens module 10 from an object side to an image side through the hollow region of the cover 30. The cover 30 may be formed of a metal material. The cover 30 may shield an electromagnetic field generated from an actuator. The cover 30 may prevent malfunction of the camera module by shielding an electromagnetic field generated from an actuator.

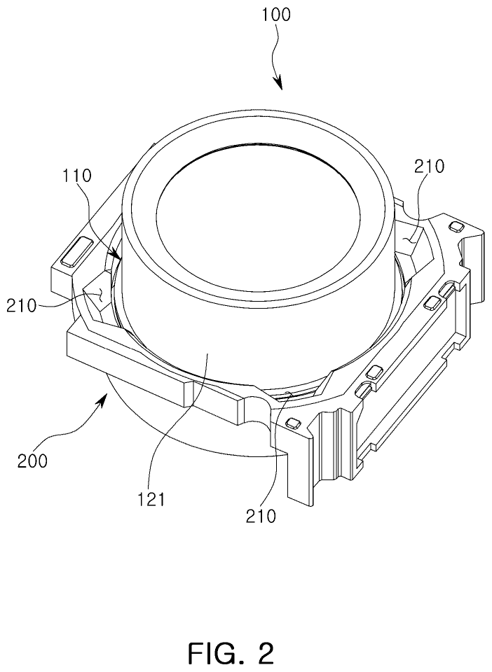

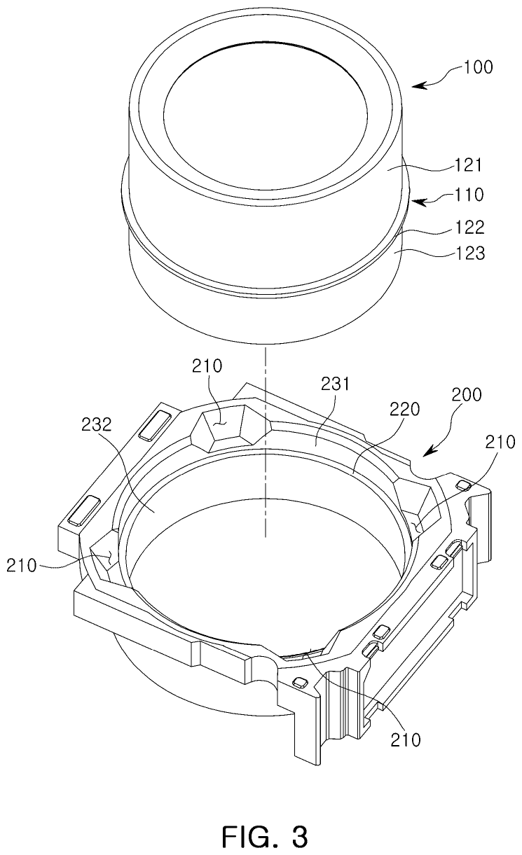

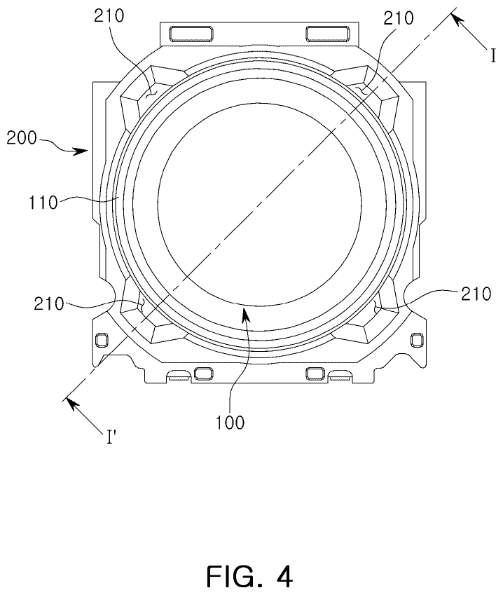

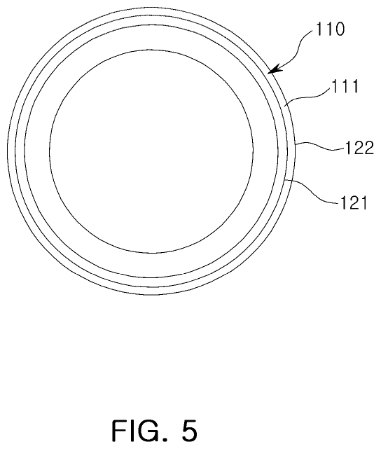

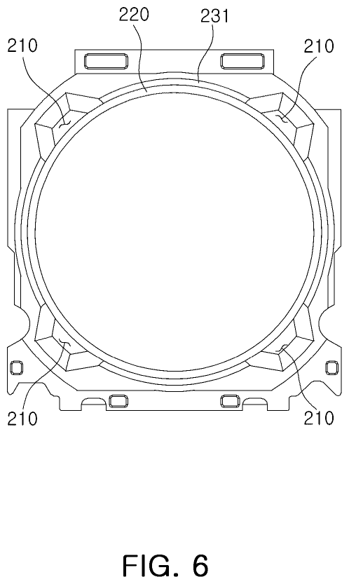

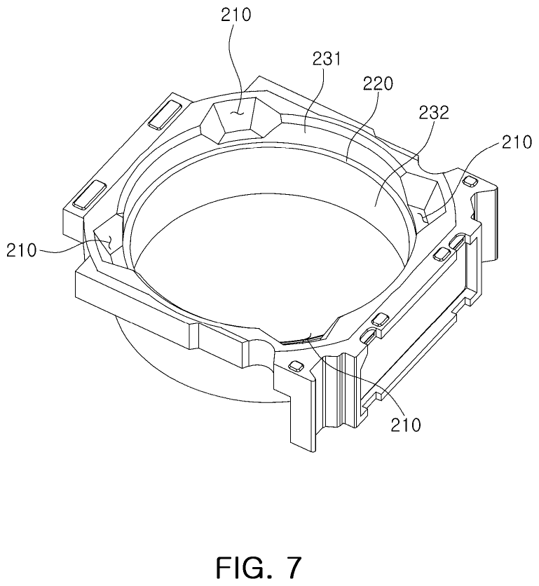

FIG. 2 is a perspective view of a lens module 10 according to an embodiment of the present disclosure. FIG. 3 is an exploded perspective view of a lens module 10 according to an embodiment of the present disclosure. FIG. 4 is a drawing of a lens module 10 as viewed from an object side. FIG. 5 is a drawing of a lens barrel 100 as viewed from an object side. FIG. 6 is a plan view of a lens holder 200 as viewed from an object side. FIG. 7 is an enlarged drawing of an injection groove 210 of a lens holder 200.

The lens module 10 may include a lens holder 200 and a lens barrel 100, and the lens holder 200 may be disposed on the outside of the lens barrel 100. That is, the lens holder 200 may have a hollow region, and at least a portion of the lens barrel 100 may be disposed in the hollow region of the lens holder 200.

A portion of an actuator may be disposed on one side of the lens holder 200. In this case, the actuator may be, for example, an actuator moving the lens holder 200 in the optical axis direction for AF driving. A magnet or coil may be disposed as a portion of the actuator on one side surface of the lens holder 200, and a ball member that may guide a movement of the lens holder 200 in the optical axis direction may also be disposed.

The lens barrel 100 may have a cylindrical shape having a hollow region. A plurality of lenses may be disposed inside the hollow region of the lens barrel 100. The lens barrel 100 may be disposed in the hollow region of the lens holder 200. An outer surface of the lens barrel 100 may face an inner surface of the lens holder 200. That is, at least a portion of the outer surface of the lens barrel 100 may have a structure corresponding to at least a portion of the inner surface of the lens holder 200.

A protrusion 110 may be disposed on the outer surface of the lens barrel 100, and a step portion 220 may be disposed on the inner surface of the lens holder 200 on which the protrusion 110 may be disposed. Details regarding the protrusion 110 and the step portion 220 will be further described later.

The lens barrel 100 may be combined with the lens holder 200. The lens barrel 100 may be disposed in the hollow region of the lens holder 200, and an adhesive may combine the lens barrel 100 and the lens holder 200.

The adhesive may be injected into the injection groove 210. The injection groove 210 may be disposed on the inner side of the lens holder 200. The injection groove 210 may include a plurality of injection grooves, and each injection groove 210 of the injection grooves may be disposed spaced apart from another along the inner surface of the lens holder 200.

The lens barrel 100 may have the protrusion 110 disposed on the outer surface. Therefore, the outer diameter of the lens barrel 100 may vary along the optical axis direction. Specifically, the lens barrel 100 may include a first outer diameter, a second outer diameter, and a third outer diameter.

Referring to FIGS. 3 and 5, the first outer diameter refers to the outer diameter of the lens barrel 100 measured in front of the protrusion 110, the second outer diameter refers to the outer diameter of the lens barrel 100 measured based on the protrusion 110, and the third outer diameter refers to the outer diameter of the lens barrel 100 measured in the rear of the protrusion 110. Here, the second outer diameter may be greater than the first outer diameter. In addition, the second outer diameter may be greater than the third outer diameter.

In other words, the lens barrel 100 may include a first outer surface 121, a second outer surface 122, and a third outer surface 123. The diameter of the first outer surface 121 may be smaller than the diameter of the second outer surface 122, and the diameter of the third outer surface 123 may be smaller than the diameter of the second outer surface 122.

The lens holder 200 may have a step portion 220 disposed on the inner surface. Therefore, the inner diameter of the lens holder 200 may vary along the optical axis direction. Specifically, the lens holder 200 may include a first inner diameter and a second inner diameter.

Referring to FIGS. 3 and 6, the first inner diameter may refer to the inner diameter of the lens holder 200 measured from the front with respect to the step portion 220, and the second inner diameter may refer to the inner diameter of the lens holder 200 measured from the rear with respect to the step portion 220.

In other words, the lens holder 200 may include a first inner surface 231 and a second inner surface 232. The first inner surface 231 may be disposed in front of the second inner surface 232, and the inner diameter of the first inner surface 231 may be greater than the inner diameter of the second inner surface 232. Accordingly, the step portion 220 may be disposed between the first inner surface 231 and the second inner surface 232.

The step portion 220 may be spaced apart from the injection groove 210 described later in the optical axis direction. In detail, the step portion 220 may be spaced apart from the bottom surface of the injection groove 210 in the optical axis direction.

When the lens barrel 100 is disposed in the hollow of the lens holder 200, the first outer surface 121 of the lens barrel 100 may be disposed facing the first inner surface 231 of the lens holder 200.

In addition, the second outer surface 122 forming the protrusion 110 of the lens barrel 100 may also be disposed facing the first inner surface 231 of the lens holder 200. That is, considering this structure, a distance between the first outer surface 121 of the lens barrel 100 and the first inner surface 231 of the lens holder 200 may be greater than a distance between the second outer surface 122 of the lens barrel 100 and the first inner surface 231 of the lens holder 200.

Additionally, the third outer surface 123 of the lens barrel 100 may be disposed facing the second inner surface 232 of the lens holder 200.

The lens holder 200 may be provided with an injection groove 210 into which adhesive is injected. The injection groove 210 may be provided in plurality. The plurality of injection grooves 210 may be provided along the inner surface of the lens holder 200. Based on the lens module 10 in which the lens holder 200 and the lens barrel 100 are combined, the plurality of injection grooves 210 may be provided along the outer surface of the lens barrel 100.

In addition, the injection groove 210 may be disposed spaced apart from the second inner surface 232 of the lens holder 200 in a direction perpendicular to the optical axis. That is, the injection groove 210 may be disposed on the outer side of the second inner surface 232 based on the optical axis.

Referring to FIG. 4, when viewing the lens module 10 from the object side, the injection groove 210 may have an approximately trapezoidal shape. However, in this case, the injection groove 210 may have a trapezoidal shape with a curved bottom. In addition, the injection groove 210 may be disposed in a corner region of the lens holder 200. Based on FIG. 4, each of the plurality of injection grooves 210 may be disposed close to each of the four corner regions of the lens holder 200.

The plurality of injection grooves 210 may be disposed radially with the optical axis as the center. Any one of the plurality of injection grooves 210 may be disposed facing another with the optical axis between them. That is, any one of the plurality of injection grooves 210 may be disposed to overlap another in a direction perpendicular to the optical axis.

Referring to FIGS. 6 and 7, the injection groove 210 may be a groove whose width changes along the optical axis direction. Specifically, the injection groove 210 may become wider as it goes upward from a bottom surface. In other words, the width of the injection groove 210 may become wider as it goes from the rear to the front of the lens holder 200 based on the optical axis.

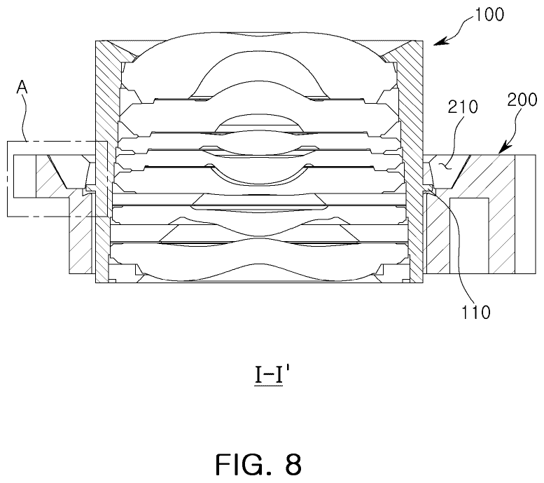

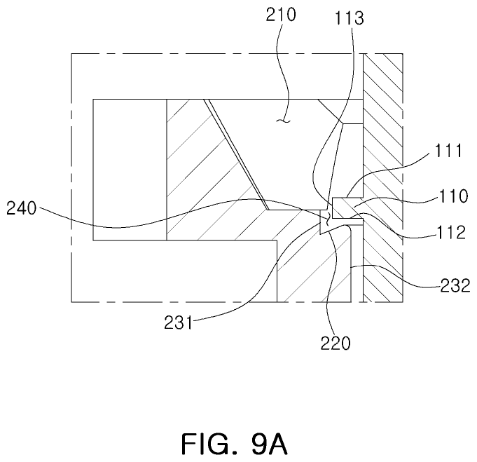

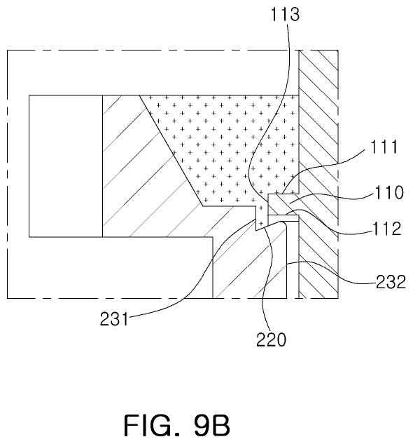

FIG. 8 is a cross-sectional view I-I′ in FIG. 4, FIG. 9A is an enlarged view of A in FIG. 8, and FIG. 9B is a view illustrating adhesive together in FIG. 9A.

Referring to FIG. 8, the protrusion 110 of the lens barrel 100 may be disposed on the seating portion 240 of the lens holder 200. In this case, the seating portion 240 may mean a groove structure formed by the step portion 220 of the lens holder 200 and a part of the first inner surface 231 of the lens holder 200.

Referring to FIGS. 7 to 9A, the seating portion 240 may be disposed to be connected to the injection groove 210. That is, one side of the bottom surface of the injection groove 210 and one side of the side surface of the seating portion 240 may be connected to each other. Here, the side surface of the seating portion 240 may mean a part of the first inner surface 231 of the lens holder 200 described above.

The seating portion 240 may include a side surface and a bottom surface. The bottom surface of the seating portion 240 refers to the step portion 220 described above. Referring to FIG. 8, FIG. 9A, and FIG. 9B, the step portion 220 may form an acute angle with the side surface of the seating portion 240.

The step portion 220 may be an inclined surface, and may form an acute angle with an axis parallel to the optical axis, and may also form an acute angle with the side surface of the seating portion 240. That is, the step portion 220 may be an inclined surface whose distance from the optical axis becomes closer as it goes from an image side to an object side. In other words, the step portion 220 may be an inclined surface whose distance from the optical axis becomes closer as it goes from an outer side of the lens holder 200 to an inner and outer sides.

The protrusion 110 of the lens barrel 100 may include a first surface 111, a second surface 112, and a third surface 113.

The first surface 111 may be a surface protruding from the outer surface of the lens barrel 100 to the outside of the lens barrel 100. The second surface 112 may be a surface protruding from the outer surface of the lens barrel 100 to the outside of the lens barrel 100. The first surface 111 and the second surface 112 may be surfaces spaced apart from each other in the optical axis direction. The third surface 113 may be a surface connecting the first surface 111 and the second surface 112.

The first surface 111 may be a surface disposed in front of the second surface 112. That is, the first surface 111 may be a surface spaced apart from the object side relative to the second surface 112.

The second surface 112 may be a surface disposed further back than the first side 111. Therefore, the second side 112 may be a surface facing the step portion 220.

The third surface 113 may refer to the second outer surface 122 of the lens barrel 100 described above. The third surface 113 may be a surface facing the side of the seating portion 240.

Below, an effect of the lens module 10 according to the present disclosure may be described with reference to FIGS. 9A and 9B.

The lens barrel 100 may be disposed in the lens holder 200, and adhesive may be injected into the injection groove 210. The injected adhesive may be an uncured fluid that may accumulate in the injection groove 210 and flow into the gap formed between the lens barrel 100 and the lens holder 200.

Referring to FIGS. 9A and 9B, the protrusion 110 may block adhesive from flowing into the image side between the lens barrel 100 and the lens holder 200.

Specifically, the first surface 111 of the protrusion 110 may block the adhesive injected into the injection groove 210 from flowing between the third outer surface 123 of the lens barrel 100 and the second inner surface 232 of the lens holder 200.

In addition, a small gap may be formed between the third surface 113 of the protrusion 110 and the side surface of the seating portion 240. The gap may be intended through design during the manufacturing of the lens module 10, or may be due to tolerances that may occur during the manufacturing of the lens barrel 100 and the lens holder 200.

Since the third surface 113 of the protrusion 110 may be disposed on the outer side of the lens barrel 100 than the third outer surface 123 of the lens barrel 100, the adhesive flowing between the third surface 113 of the protrusion 110 and the side surface of the seating portion 240 may be prevented to flow into the gap between the third outer surface 123 of the lens barrel 100 and the second inner surface 232 of the lens holder 200.

In addition, since the step portion 220 may be an inclined surface getting closer to an object side as it goes from the outside to the inside of the lens holder 200, it may prevent the adhesive from flowing between the third surface 113 of the protrusion 110 and the side surface of the seating portion 240 from flowing into the inside of the lens holder 200.

In summary, the lens module 10 according to the embodiment of the present disclosure may have an effect of preventing deformation of the lens barrel 100 due to the curing of the adhesive by flowing an adhesive between the third outer surface 123 of the lens barrel 100 and the second inner surface 232 of the lens holder 200.

An aspect of the present disclosure is to provide a lens module capable of preventing an adhesive from flowing out between a lens barrel and a lens holder outside of a proper application region.

A lens module according to an embodiment of the present disclosure may have the advantage of preventing deformation of the lens barrel or lens holder due to adhesive flowing down between the lens holder and the lens barrel, thereby improving the reliability of an optical performance of the camera module.

While specific examples have been shown and described above, it will be apparent after an understanding of this disclosure that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A lens module, comprising:
a lens holder having a hollow region; and
a lens barrel disposed in the hollow region,
wherein a protrusion is disposed on an outer surface of the lens barrel,
wherein an injection groove, configured to accommodate an adhesive, is disposed on the lens holder,
wherein a seating portion, connected to the injection groove, is disposed on an inside surface of the lens holder, and
wherein the protrusion is disposed on the seating portion.

2. The lens module of claim 1, wherein the seating portion comprises a step portion forming a bottom surface of the seating portion, and
wherein the step portion is spaced apart from the injection groove in an optical axis direction.

3. The lens module of claim 2, wherein the step portion is disposed closer to an image side than the bottom surface of the injection groove.

4. The lens module of claim 2, wherein the step portion is an inclined surface extending from a surface of the lens holder.

5. The lens module of claim 2, wherein the step portion forms an acute angle with a side surface of the seating portion.

6. The lens module of claim 2, wherein the step portion is ring-shaped when viewed from an object side.

7. The lens module of claim 6, wherein the protrusion is ring-shaped and corresponds to the step portion.

8. The lens module of claim 2, wherein the protrusion comprises:
a first surface;
a second surface spaced apart from the first surface in the optical axis direction; and
a third surface connecting the first surface and the second surface, and
wherein the second surface faces the bottom surface of the seating portion.

9. The lens module of claim 8, wherein the third surface faces a side surface of the seating portion.

10. The lens module of claim 8, wherein the first surface is disposed closer to an object side than the second surface.

11. The lens module of claim 1, wherein the injection groove is trapezoidal shaped with a curved bottom when viewed from an object side.

12. The lens module of claim 1, wherein the injection groove is disposed in plurality, and
wherein each injection groove of the plurality is disposed spaced apart from another along an inner surface of the lens holder.

13. The lens module of claim 1, wherein the injection groove becomes wider when viewed from an image side to an object side.

14. The lens module of claim 1, wherein the adhesive is injected into the injection groove.

15. A camera module, comprising:
a housing;
a lens module, disposed within the housing, comprising a lens holder having a hollow region, and a lens barrel disposed in the hollow region; and
a cover accommodating the housing,
wherein the lens holder has a first inner surface, a second inner surface having a smaller inner diameter than the first inner surface, and an injection groove accommodating an adhesive, and
wherein the injection groove is spaced apart from the second inner surface of the lens holder in a direction perpendicular to an optical axis.

16. The camera module of claim 14, wherein a step portion is disposed between the first inner surface and the second inner surface of the lens holder.

17. The camera module of claim 15, wherein the step portion is spaced apart from a bottom surface of the injection groove in a direction parallel to the optical axis.
